(19) United States
(12) Patent Application Publication
(10) Pub. No.: US 2019/0312400 A1
(43) Pub. Date: Oct. 10, 2019

(54) Flat plane laser light

(71) Applicant: William Delaplaine Green, JR., Alexandria, VA (US)

(72) Inventor: William Delaplaine Green, JR., Alexandria, VA (US)

(21) Appl. No.: 15/932,706

(22) Filed: Apr. 10, 2018

(51) Int. Cl. H01S 3/00

(52) U.S. Cl. CPC H01S 3/0071

(57) ABSTRACT

The laser light is comprised of a power source 22 electrically connected to a laser light source 24 of coherent light that is reflected from a mirror 26 to produce a flat plane laser light 28.

This is a United States Utility Patent Application based on a United States Provisional Patent Application mailed to the Commissioner for Patents, P.O. Box 1450, Alexandria, Va. 22313-1450 in the Express Mail on Apr. 10, 2017, tracking number EL804310129 US.

### BACKGROUND OF THE INVENTION

The invention is a laminar laser light that produces a flat plane laser light source that may be made any desired thickness down to a specified minimum or up to a maximum thickness so the desired effect of the laser light will result from the use of this type of laser light.

### BRIEF DESCRIPTION OF THE DRAWING FIGS.

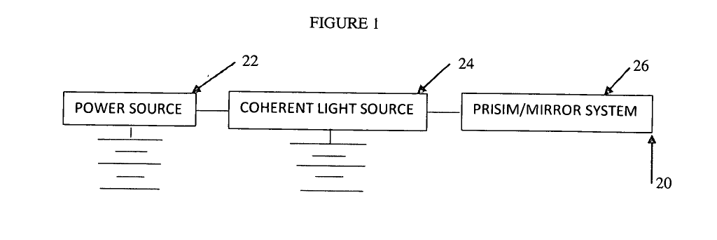

1. FIG. 1 is an electronic circuit of the specified laminar laser light.

### DETAILED DESCRIPTION OF THE PREFERRED EMBODIMENT

The invention is generally illustrated with drawing numeral 20. The laser light is comprised of a power source 22 electrically connected to a laser light source 24 of coherent light that is reflected from a mirror 26 to produce a flat plane laser light 28.

What I claim is:

1. The laser light is comprised of a power source 22 electrically connected to a laser light source 24 of coherent light that is reflected from a mirror 26 to produce a flat plane laser light 28.
